(19) United States
(12) Patent Application Publication
(10) Pub. No.: US 2024/0085449 A1
(43) Pub. Date: Mar. 14, 2024

(54) Electronic Devices With Anemometers

(71) Applicant: Apple Inc., Cupertino, CA (US)

(72) Inventors: David MacNeil, San Mateo, CA (US); Michael J. Glickman, Mountain View, CA (US); John P. Bergen, San Jose, CA (US); Richard Yeh, Los Altos, CA (US)

(21) Appl. No.: 18/350,590

(22) Filed: Jul. 11, 2023

Related U.S. Application Data
(60) Provisional application No. 63/405,112, filed on Sep. 9, 2022.

(51) Int. Cl. G01P 5/24; G01W 1/02

(52) U.S. Cl. CPC G01P 5/248; G01W 1/02

(57) ABSTRACT

An electronic device may include a housing and a display in the housing. The display may be used as an anemometer to measure the speed of ambient air in the device's environment. In particular, the display may be monitored by a temperature sensor until it reaches an equilibrium temperature, at which point it may be heated by increasing the brightness of the display or using a separate heater. After heating, a cooling response of the display may be measured, and the ambient air speed may be calculated based on the cooling response of the display. Instead of measuring the air speed using the display, other components, such as a pressure sensor, may be used to measure the air speed by heating the components and measuring a cooling response of the components. Multiple temperature sensors may be incorporated into the device to determine a wind direction in addition to air speed.

This application claims the benefit of U.S. provisional patent application No. 63/405,112, filed Sep. 9, 2022, which is hereby incorporated by reference herein in its entirety.

### FIELD

This relates generally to electronic devices, and, more particularly, to electronic devices with environmental sensors.

### BACKGROUND

Electronic devices such as laptop computers, cellular telephone, and other equipment are sometimes provided with environmental sensors, such as ambient light sensors, image sensors, and microphones. However, it may be difficult to incorporate some environmental sensors into an electronic device where space is at a premium.

### SUMMARY

An electronic device, such as a wrist watch device or other wearable electronic device, may include a housing and a display in the housing. The display may be used as an anemometer to measure the speed of ambient air in the device's environment. In particular, the display may be monitored by a temperature sensor until it remains at an equilibrium temperature within a given threshold. After reaching the equilibrium temperature, the display may be heated. For example, the brightness of the display may be increased (e.g., to a maximum brightness), or a separate heater that is adjacent to the display may be used to heat the display. After heating the display, the temperature sensor may be used to measure a cooling response of the display. Based on a thermal energy balance, the ambient air speed may be calculated based on the cooling response of the display.

Multiple temperature sensors may be used to measure the display temperature, if desired. For example, multiple temperature sensors arranged across the display may be used to determine a wind direction based on which temperature sensors measure colder temperatures than the other temperature sensors.

Instead of measuring the air speed using the display, other components, such as a pressure sensor that has integrated temperature sensors, may be used to measure the air speed by heating the components and measuring a cooling response of the components.

### BRIEF DESCRIPTION OF THE DRAWINGS

FIG. 1 is a drawing of an illustrative wearable electronic device in accordance with various embodiments.

FIG. 2 is a diagram of an illustrative electronic device in accordance with various embodiments.

FIG. 3 is a side view of an illustrative device with a display used to measure air speed in accordance with various embodiments.

FIG. 4 is a flowchart of illustrative steps used in operating a display to measure air speed in accordance with various embodiments.

FIG. 5 is a graph of illustrative relationships of display cooling responses in different environmental conditions in accordance with various embodiments.

FIG. 6 is a front view of an illustrative device having multiple temperature sensors in accordance with an embodiment.

FIG. 7 is a side view of an illustrative device with a heater and temperature sensor used to measure air speed in accordance with various embodiments.

### DETAILED DESCRIPTION

Electronic devices are often carried by users as they conduct their daily activities. For example, a user may carry an electronic device on their person throughout the day while walking, commuting, working, exercising, etc. In some situations, it may be desirable for the user to know the speed of ambient air in the device's environment. For example, the air speed may be used in combination with fitness applications (e.g., when calculating a user's power output while exercising in the wind), weather sensing and/or forecasting, temperature measurement, and/or or other desired functions.

To make air speed measurements, a component within the electronic device may be heated. For example, a display within the electronic device may be heated, such as by increasing the brightness of the display, or by heating the device with a separate heating element. Alternatively, the component may be a sensor that has a heater and temperature sensor. Regardless of the component used, control circuitry may then monitor the cooling response of the component to determine the air speed, as the cooling response of the component is proportional to the air speed (in addition to other physical inputs such as incident radiant flux). In this way, anemometers may be integrated into electronic devices.

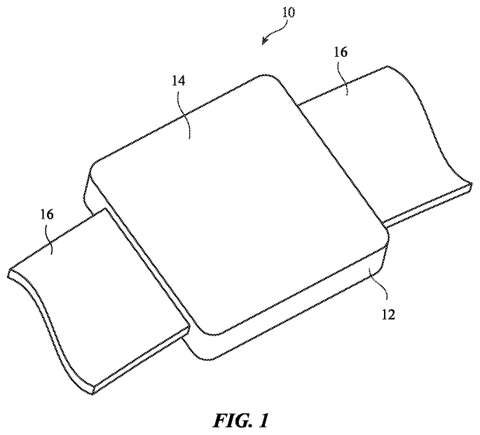

In general, any suitable electronic devices may include these anemometers. As shown in FIG. 1, a wearable electronic device 10, which may be a wristwatch device, may have a housing 12, a display 14, and a strap 16. In particular, display 14 may be on a front face of wearable device 10. The wristwatch may attach to a user's wrist via strap 16. When worn on the user's wrist, a rear face of wearable device 10 (i.e., a rear surface of housing 12) may contact or be oriented toward the user's wrist. In some embodiments, device 10 may include various sensors that are in contact with the user's wrist, and the sensors may gather health or activity data (e.g., heart rate data or blood oxygen data) from the user.

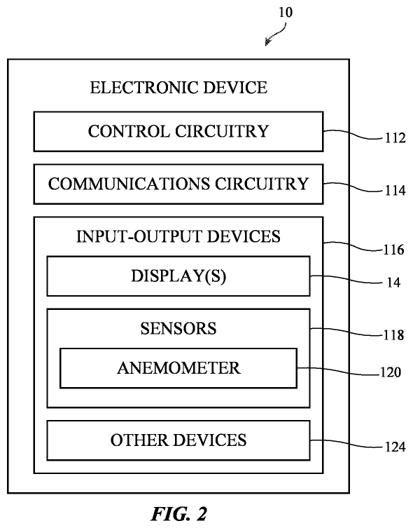

Although FIG. 1 shows electronic device 10 shown as a wristwatch device, this is merely illustrative. In general, electronic device 10 may be any desired device, such as a media player, or other handheld or portable electronic device, a cellular telephone device (e.g., smartphone), a wristband device, a pendant device, a headphone, a speaker, a smart speaker, an ear bud or earpiece device, a head-mounted device such as glasses, goggles, a helmet, or other equipment worn on a user's head, or other wearable or miniature device, a navigation device, or other accessory, and/or equipment that implements the functionality of two or more of these devices. Illustrative configurations in which electronic device 10 is a portable electronic device such as a cellular telephone, wristwatch, or portable computer may sometimes be described herein as an example. Regardless of the form factor of device 10, an illustrative schematic diagram of device 10 is shown in FIG. 2.

As shown in FIG. 2, electronic devices such as electronic device 10 may have control circuitry 112. Control circuitry 112 may include storage and processing circuitry for controlling the operation of device 10. Circuitry 112 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 112 may be based on one or more microprocessors, microcontrollers, digital signal processors, baseband processors, power management units, audio chips, graphics processing units, application specific integrated circuits, and other integrated circuits. Software code may be stored on storage in circuitry 112 and run on processing circuitry in circuitry 112 to implement control operations for device 10 (e.g., data gathering operations, operations involving the adjustment of the components of device 10 using control signals, etc.).

Electronic device 10 may include communications circuitry 114, which may include wired and/or wireless communications circuitry. For example, electronic device 10 may include radio-frequency transceiver circuitry, such as cellular telephone transceiver circuitry, wireless local area network transceiver circuitry (e.g., WiFi® circuitry), short-range radio-frequency transceiver circuitry that communicates over short distances using ultra high frequency radio waves (e.g., Bluetooth® circuitry operating at 2.4 GHz or other short-range transceiver circuitry), millimeter wave transceiver circuitry, and/or other wireless communications circuitry.

Device 10 may include input-output devices 116. Input-output devices 116 may be used to allow a user to provide device 10 with user input. Input-output devices 116 may also be used to gather information on the environment in which device 10 is operating. Output components in devices 116 may allow device 10 to provide a user with output and may be used to communicate with external electrical equipment.

Input-output devices 116 may include one or more optional displays such as displays 14. Displays 14 may be organic light-emitting diode displays or other displays with light-emitting diodes, liquid crystal displays, microLED displays, or other displays. Displays 14 may be touch sensitive (e.g., displays 14 may include two-dimensional touch sensors for capturing touch input from a user) and/or displays 14 may be insensitive to touch.

Input-output devices 116 may include sensors 118. Sensors 118 may include, for example, temperature sensors (e.g., thermometers or thermocouples), three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors (e.g., a magnetometer), audio sensors (microphones), ambient light sensors, microphones for gathering voice commands and other audio input, sensors that are configured to gather information on motion, position, and/or orientation (e.g., accelerometers, gyroscopes, pressure sensors, compasses, and/or inertial measurement units that include all of these sensors or a subset of one or two of these sensors), health sensors that measure various biometric information (e.g., heartrate sensors, such as a photoplethysmography sensor), electrocardiogram sensors, and perspiration sensors) and/or other sensors.

Sensors 118 may also include one or more anemometers 120. Anemometer(s) 120 may be incorporated into device 10 using display 14 and/or other component that is heated, and control circuitry may determine ambient air speed based on the cooling response of display 14 or another component. If display 14 is used to form anemometer 120, display 14 may be heated by increasing the brightness of the display or may be heated using a separate heat source. Based on the amount of heat that is input to the display and the rate at which the display cools, the air speed may be calculated. Alternatively, another component, such as a heater in a sensor (e.g., one of sensors 118), may be used to form anemometer 120.

If desired, input-output devices 116 may include other devices 124 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

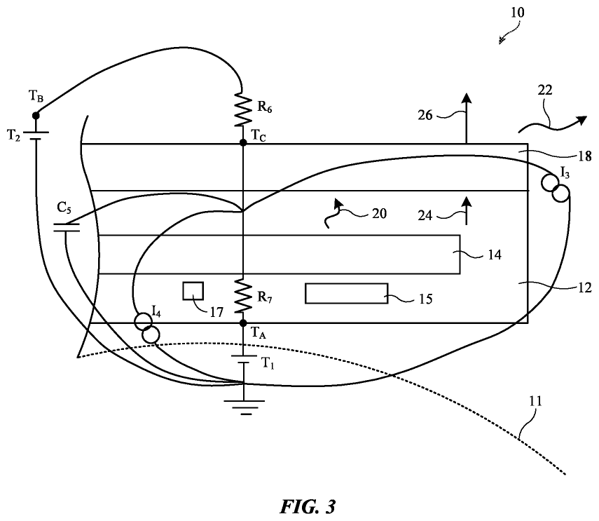

In general, any desired component that is conductive to heat may be used as an anemometer within an electronic device, as the component may be heated and a cooling response measured to determine the air speed. An illustrative example of a device having an anemometer formed from a display is shown in FIG. 3.

As shown in FIG. 3, device 10 may be in contact with a portion 11 of a user. In some embodiments, device 10 may be a watch that is contact with wrist 11 of a user. To sense ambient air speed in the environment of device 10, display 14 may be heated, and a cooling response of device 10 may be determined. Display 14 may be heated by increasing the brightness of the display (e.g., to a maximum brightness) or by using a heater that is separate from display 14, such as heater 15. Heater 15 may be interposed between display 14 and housing 12 (e.g., a rear portion/surface of housing 12). The temperature of display 14 may be measured using a temperature sensor (e.g., thermistor or thermocouple) adjacent to display 14. For example, as shown in FIG. 3, temperature sensor 17 may measure the temperature of display 14 to determine the temperature and cooling response of the display.

Display 14 may lose (or gain) heat through convection 20 between display 14 and display cover layer 18. Housing 12, in which display 14 is mounted, may lose (or gain) heat through conduction 24 between housing 12 and display cover layer 18. Additionally, cover layer 18 may lose (or gain) heat through convection 22 and/or radiation 26 (e.g., solar radiation). The transfer of heat from wrist 11, device 10, and the surrounding environment may also be modeled as a circuit diagram, as shown in FIG. 3. In particular, wrist 11 may have temperature T1, the ambient air may have ambient temperature T2, and device 10 may have heat capacitance C5. Device 10 may also produce internal heat 14 (e.g., due to a battery and/or other components within device 10), and gain or lose additional heat through radiation 13.

An energy balance may produce Equation 1,

$$\\ \begin{matrix}{R}_{6} = \frac{{R}_{7} ( {T}_{b} - {T}_{c} )}{{Q}_{3} {R}_{7} + {Q}_{4} {R}_{7} + {T}_{a} - {T}_{c} + {C}_{5} {R}_{7} {\dot{T}}_{c}} & ( 1 )\end{matrix}$$

where R is the resistance at the designated location in FIG. 3, Q is the heat at the designated location in FIG. 3, T is the temperature at the designated location in FIG. 3, and C is the heat capacitance at the designated location in FIG. 3.

Additionally, R6 may be related to the air speed based on Equation 2 (determined empirically),

$$\\ \begin{matrix}{R}_{6} = \frac{1}{8.3 {A}_{surface} {v}^{0.6}} & ( 2 )\end{matrix}$$

where A_{surface} is the area of display 14 (i.e., an upper surface of display 14) and v is the ambient air speed.

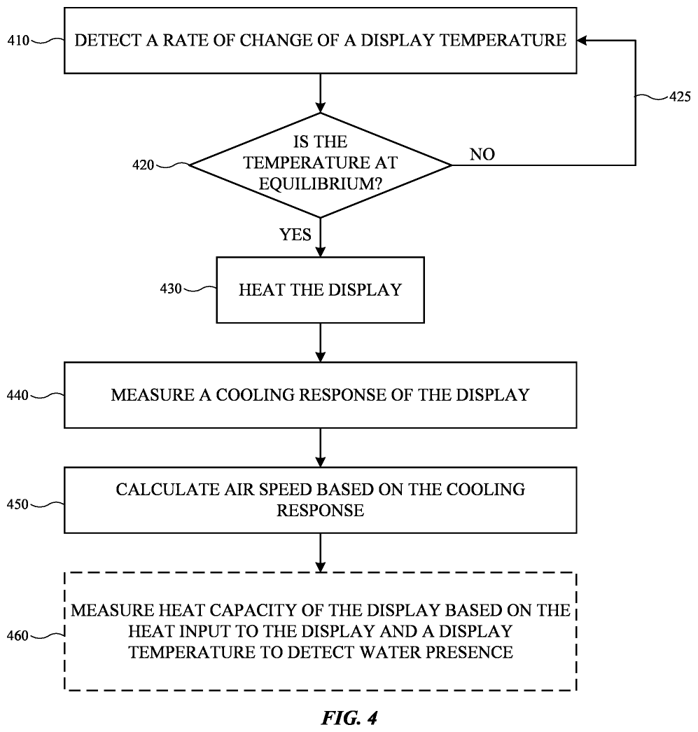

Combining Equation 1 and Equation 2, the unknowns are Q3, which is the amount of radiation and may be estimated in the shade based on ambient light sensor measurements, R6, Tb, and v. To solve for v, R6 and Tb may be determined by heating the display by a known amount and measuring a cooling response of the display. In this way, v, the ambient air speed, may be measured using display 14 operated as anemometer 120 in display 10. A flowchart of illustrative steps that may be used in measuring air speed with display 14 is shown in FIG. 4.

As shown in FIG. 4, at step 410, circuitry within an electronic device, such as control circuitry 112 of device 10, may detect a rate of change of the temperature of a display (Tc of Equation 1 and FIG. 3), such as display 14. In some examples, device 10 may have a temperature sensor, such as temperature sensor 17 of FIG. 3, adjacent to the display. Alternatively or additionally, a temperature sensor may be incorporated into the display, or circuitry within device 10 may otherwise determine a temperature of the display.

At step 420, the circuitry may determine whether the temperature of the display is at equilibrium. For example, the circuitry may determine whether the temperature of the display is constant within a given threshold (i.e., that the rate of change of the display temperature is changing by less than a given amount). If the temperature is not at equilibrium within the threshold, the flowchart may proceed along line 425, and the circuitry may continue to detect the rate of change of the display temperature.

In response to determining that the display temperature is at equilibrium, at step 430, circuitry within the device may heat the display. For example, the circuitry may increase the brightness of the display to heat the display. In some embodiments, the display brightness may be increased to a maximum level to heat the display. Alternatively, a heater within the device may be used to heat the display. For example, the device may include a heater, such as heater 15 of FIG. 3, adjacent to the display (e.g., between display 14 and housing 12 of FIG. 3).

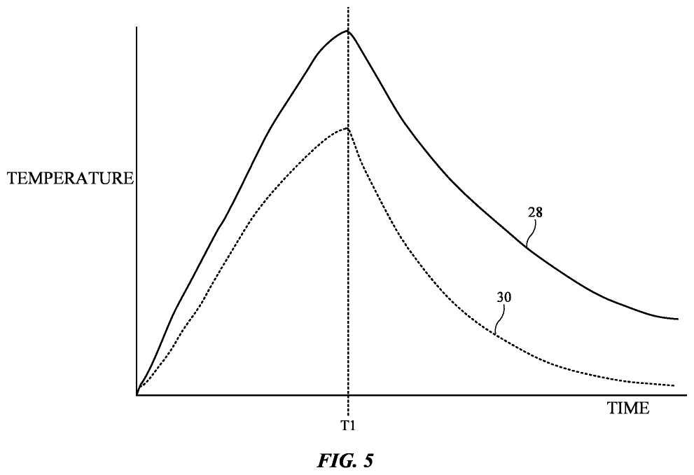

At step 440, a cooling response of the display may be measured. For example, control circuitry may determine a maximum temperature and decay time of the display using a temperature sensor, such as temperature sensor 17. The cooling response may be measured as the time required for the display to cool to a given temperature, or as a temperature that the display reaches in a given time. In some embodiments, multiple measurements of display temperature may be taken, and a curve may be fit to the multiple display temperature measurements. The curve may be the cooling response. At higher air speeds, both the maximum temperature and the decay time may be lower. Illustrative cooling responses at different air speeds are shown in FIG. 5.

Curve 28 of FIG. 5 shows illustrative temperatures of the display over time at a first air speed. As shown in FIG. 5, the display may be heated until time T1, at which the display reaches a maximum temperature (a maximum temperature on curve 28 of FIG. 5, e.g., a maximum temperature reached by the display while determining the air speed using the display). After time T1, the display may cool (e.g., according to a logarithmic cooling curve). In other words, the display may have a cooling response after time T1.

Curve 30 shows illustrative temperatures of the display over time at a second air speed that is greater than the first air speed. As shown in FIG. 5, the maximum temperature (a maximum temperature on curve 30 of FIG. 5, e.g., a maximum temperature reached by the display while determining the air speed using the display) of the display at the second air speed at time T1 may be lower than the maximum temperature of the display at the first air speed. Additionally, the display may have a faster cooling response at the second air speed than at the first air speed.

Returning to FIG. 4, at step 450, the control circuitry may calculate an ambient air speed based on the cooling response of the display. In particular, the control circuitry may first use the cooling response and the amount of heat input into the display to solve for R6 and Tb of Equation 1. The control circuitry may then determine air speed v using Equations 1 and 2. In this way, the display may be used as an anemometer to measure ambient air speed.

At step 460, the heat capacity of the display may optionally be measured. In particular, the heat capacity of the display may be measured based on the heat input to the display (e.g., the amount of heat from the increase in brightness or from the heater) and the display temperature. In some embodiments, the heat capacity of the display may be measured to detect whether water is present in the environment of the electronic device. In general, however, the heat capacity of the display may be measured for any desired purpose or secondary measurement.

Although not shown in FIG. 4, the control circuitry may also determine whether the display is shaded or the extent to which the display is shaded prior to using the display to measure air speed. For example, an ambient light sensor in the electronic device may be used to determine the intensity of the light incident on the device, which may indicate the amount of shade on the display. By measuring the extent to which the display is shaded, the control circuitry may determine or estimate the radiation incident on the electronic device, which may be used as Q3 in Equation 1.

Device 10 has been described as including temperature sensor 17 adjacent to display 14. Although a single temperature sensor is shown in FIG. 3, this is merely illustrative. In general, device 10 may include any desired number of temperature sensors. A front view of an illustrative device having multiple temperature sensors is shown in FIG. 6.

As shown in FIG. 6, device 10 may have multiple temperature sensors at locations 32 across display 14. For example, each temperature sensor may be behind display 14 (between display 14 and rear housing 12 of FIG. 3) at locations 32. By having multiple temperature sensors, a direction of wind may be determined along with the wind speed. In particular, temperature sensors that are upstream toward the wind may measure a colder temperature than temperature sensors that are downstream of the wind. For example, if the temperature sensors on the right side of the display in the orientation of FIG. 6 measure a colder temperature than the temperature sensors on the left of the display, then control circuitry may determine that the wind direction is from right to left. In addition to determining wind direction, having multiple temperature sensors across display 14 may allow for more accurate measurements of display temperature and therefore air speed. In some examples, the temperatures measured by the multiple temperature sensors may be averaged, weighted, or otherwise combined to determine display temperature. Alternatively, each measured temperature may be used to separately calculate air speed.

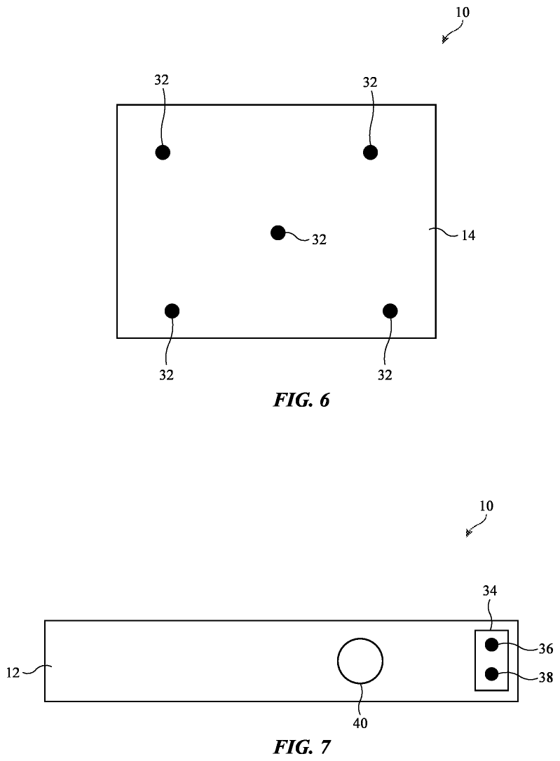

Although electronic devices have been described using a display as an anemometer to measure air speed, this is merely illustrative. If desired, another component instead of the display may be used to as an anemometer to measure air speed. An illustrative example of a device using other components for an anemometer is shown in FIG. 7.

As shown in FIG. 7, device 10 may have components 34 and 40 on housing 12. Component 34 may be, for example, an environmental sensor within device 10. In some embodiments, component 34 may be a pressure sensor or a MEMS (micro-electromechanical systems) gas sensor. Component 34 may include temperature sensor 36 and heater 38 (as well as other components, such as control circuitry). In embodiments in which component 34 is a MEMS gas sensor, heater 38 may be a MEMS heater, and temperature sensor 36 may be an integrated temperature sensor. Component 34 may also be a combination environmental sensor, such as a sensor that includes a pressure sensor, a MEMS gas sensor, a temperature sensor, and a humidity sensor in a single package.

To operate component 34 as an anemometer to measure air speed, the same method described in connection with FIG. 4 may be used. In particular, a rate of change of the temperature of component 34 may be monitored using temperature sensor 36 until the temperature reaches equilibrium. After the temperature reaches equilibrium, heater 38 may be used to heat component 34, and temperature sensor 36 may be used to determine a maximum temperature and a cooling response of component 34. Control circuitry in device 10 may then calculate an air speed based on the cooling response using Equations 1 and 2.

Alternatively or additionally, component 40, which may be a crown on the side of device 10 (e.g., a rotatable component that allows for user interaction with device 10) may include a heater and temperature sensor and be operated in the same manner as described in connection with component 34. For example, a heater and temperature sensor may be incorporated under an outer surface of component 40 to measure the temperature of component 40, heat component 40, and measure a cooling response of component 40.

The examples shown in FIG. 7 of using component 34 and/or component 40 as an anemometer are merely illustrative. In general, a heater and temperature sensor may be incorporated anywhere within device 10, such as within housing 12 or on housing 12. The heater and temperature sensor may then be used to determine an ambient air speed.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is illustrative and various modifications can be made to the described embodiments. The foregoing embodiments may be implemented individually or in any combination.

What is claimed is:

1. An electronic device configured to be worn by a user, comprising:
a housing having a front and a rear, wherein the rear of the housing is configured to contact the user when the electronic device is worn;
a display at the front; and
control circuitry configured to heat the display from a first temperature to a second temperature, and to determine an ambient air speed based on a cooling response of the display.

2. The electronic device of claim 1, wherein the control circuitry is configured to heat the display by changing a brightness of the display from a first brightness level to a second brightness level that is greater than the first brightness level.

3. The electronic device of claim 2, further comprising:
a display temperature sensor interposed between the display and the rear of the housing, wherein the control circuitry is configured to determine the first temperature and the second temperature based on measurements from the display temperature sensor.

4. The electronic device of claim 1, further comprising:
a heater interposed between the display and the rear of the housing, wherein the control circuitry is configured to heat the display using the heater.

5. The electronic device of claim 1, further comprising:
an array of temperature sensors interposed between the display and the rear of the housing.

6. The electronic device of claim 5, wherein the control circuitry is configured to determine the first temperature and the second temperature based on measurements from the array of temperature sensors.

7. The electronic device of claim 6, wherein the first and second temperatures vary across the display, and wherein the control circuitry is further configured to determine a wind direction based on a variance of the measurements from the array of temperature sensors.

8. The electronic device of claim 1, further comprising:
an ambient light sensor in the housing, wherein the control circuitry is configured to determine whether the display is shaded based on measurements from the ambient light sensor.

9. The electronic device of claim 1, wherein the control circuitry is further configured to determine a heat capacity of the display based on the heat input to the display and the second temperature, and to detect water based on the heat capacity of the display.

10. A method of operating an electronic device having a display, a display temperature sensor, and control circuitry that drives the display, comprising:
detecting a rate of change of a temperature of the display;
in response to determining that the temperature of the display has reached an equilibrium within a threshold, heating the display from a first temperature to a second temperature;
measuring a cooling response of the display; and
calculating an air speed based on the cooling response of the display.

11. The method of claim 10, wherein heating the display comprises increasing a brightness of the display from a first brightness level to a second brightness level that is higher than the first brightness level.

12. The method of claim 11, wherein increasing the brightness of the display to the second brightness level comprises increasing the brightness of the display to a maximum brightness level.

13. The method of claim 10, wherein heating the display comprises heating the display with a heater that is adjacent to the display.

14. The method of claim 10, further comprising:
determining whether the display is in the shade using an ambient light sensor.

15. The method of claim 10, further comprising:
measuring a heat capacity of the display based on the heating of the display and the second temperature; and
detecting the presence of water based on the measured heat capacity.

16. The method of claim 10, wherein measuring the cooling response of the display comprises measuring a plurality of cooling responses across the display to determine a wind direction.

17. The method of claim 10, wherein measuring the cooling response of the display comprises measuring a time required for the display to cool to a given temperature.

18. The method of claim 10, wherein measuring the cooling response of the display comprises measuring a temperature that the display cools to after a given period of time.

19. The method of claim 10, wherein measuring the cooling response of the display comprises taking multiple display temperature measurements over time and fitting a curve to the multiple display temperature measurements.

20. An electronic device, comprising:
a housing;
a heat source in the housing;
a temperature sensor in the housing; and
control circuitry configured to heat a portion of the electronic device from a first temperature to a second temperature using the heat source, and to determine an ambient air speed based on a cooling response of the portion of the electronic device.

21. The electronic device of claim 20, further comprising:
a pressure sensor, wherein the temperature sensor and the heat source are within the pressure sensor.

22. The electronic device of claim 20, further comprising:
a wrist strap coupled to the housing; and
a crown coupled to the housing, wherein the heat source and temperature sensor are in the crown.

23. The electronic device of claim 20, further comprising:
a display at a front of the housing, wherein the heat source is coupled between the display and a rear portion of the housing, and the control circuitry is configured to heat the display using the heat source.

24. The electronic device of claim 20, wherein the heat source and temperature sensor are within a single component.

25. The electronic device of claim 24, wherein the single component comprises a MEMS gas sensor, the heat source is a MEMS heater, and the temperature sensor is an integrated temperature sensor.

26. The electronic device of claim 25, wherein the single component further comprises a pressure sensor and a humidity sensor.
